(19) United States
(12) Patent Application Publication
(10) Pub. No.: US 2009/0321092 A1
(43) Pub. Date: Dec. 31, 2009

(54) FIRE FIGHTING DEVICE WITH WATERWAY

(75) Inventors: Eric Nathaniel Combs, Goshen, IN (US); Donald E. Sjolin, Granger, IN (US); Todd Brian Lozier, Elkhart, IN (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Elkhart Brass Manufacturing Company, Inc., Elkhart, IN (US)

(21) Appl. No.: 12/488,025

(22) Filed: Jun. 19, 2009

Related U.S. Application Data
(60) Provisional application No. 61/074,365, filed on Jun. 20, 2008.

(51) Int. Cl. A62C 31/00

(52) U.S. Cl. 169/51; 29/890.12

(57) ABSTRACT

A method of forming a fire fighting monitor includes forming a core in the shape of a non-linear waterway of a monitor body, applying a composite material over the core, and then curing the composite material to thereby form the fire fighting monitor body.

### CROSS-REFERENCE TO RELATED APPLICATIONS

This application claims the benefit and priority to Provisional Application Ser. No. 61/074,365, filed Jun. 20, 2008, entitled FIRE FIGHTING DEVICE WITH WATERWAY, which is incorporated by reference herein in its entirety.

### TECHNICAL FIELD AND BACKGROUND OF THE INVENTION

The present invention generally relates to fire fighting devices with waterways and, more particularly, to fire fighting monitors.

Fire fighting devices, such as fire fighting monitors, often are used in industrial or marine environments where large water supplies and the potential for large scale fire hazards exist. While large flow capacity monitors have been in the past limited to fixed instillations, more recent style fire trucks are utilizing larger flow capacity monitors.

Typically, monitors are either constructed from fabricating a waterway from welded and bent metal tube, or from cast and machined metal bodies. The monitors are either constructed of aluminum, brass, or steel. Due to the requirements of the waterway, the resulting end product is a very bulky, heavy, and expensive to manufacture. The weight and size of these monitors create problems in mounting to a traditional fire truck. These constraints would make it extremely difficult to use these monitors on a platform or arial fire truck.

In addition to large flow capacity monitors, conventional monitors currently on the market are produced by bulk forming and finishing of metals into shapes that provide a suitable waterway and typically includes means for vertical and horizontal rotation. However, as in the case of large flow capacity monitors, the current manufacturing methods are limited to forming the monitors from metal, and similarly require large capital investments in machinery capable of producing the bulk shapes and handling the bulky geometries for finishing (such as machining), which typically include foundry patterns and core boxes, or mandrels for bending tube.

Consequently, there is a need for an improved design for monitors that will reduce bulk, weight, and cost of manufacturing, and especially for large flow capacity monitors whose weight may limit their application.

### SUMMARY OF THE INVENTION

Accordingly, the present invention provides a monitor and other fire fighting devices with waterways that have reduced weight and cost of manufacturing, using non-conventional techniques.

In one form of the invention, a method of forming a fire fighting monitor includes forming a core in the shape of the waterway of the monitor, and applying a composite material over the core. Once applied, the composite material is cured to thereby form the fire fighting monitor body. After the fire fighting monitor body is at least partially cured, the core may then be removed.

In one aspect, the core is formed from wax, salt, rapid prototype powder, sand, an inflatable bladder, or a slightly rigid, but low friction material. For example, when the core is formed from an inflatable bladder, the bladder may be deflated before removing the inflatable bladder. When the core is made from a slightly rigid, but low friction material, such as TEFLON, the material may be reinforced by an outer layer that provides structural integrity to the low friction material. For example, suitable outer layers may include layer of glass filled nylon, over molding using a polymer, or fiberglass. In this application, the core may be left in place.

In other aspects, the core is cured by exposing the core to an elevated temperature, for example by heating the core in an oven.

In yet other aspects, the composite material comprises a fabric. For example, the fabric may be applied by wrapping the core in the fabric.

According to yet other aspects, an insert is formed, for example by molding or machining, and is located on or in the core. Further, the insert may be formed with at least one recess so that the composite material can extend into the recess when the composite material is applied over the core to thereby mechanically couple the composite material to the insert.

In addition, the insert may be coupled to the core. For example, the insert may be coupled by a friction fit or a compression fit between the insert and the core.

In other aspects, the core may include a recess, with the insert positioned in the recess to thereby locate the insert on or in the core.

According to yet other aspects, the composite material may be sprayed over the core, and any inserts.

Additionally, a reinforcing member or members may be incorporated into or on composite material. For example, the reinforcing member or members may be located in or on the composite material before or during the curing process. Suitable reinforcing members may include metal bands or plates.

According to another form of the invention, a fire fighting monitor includes a monitor body with a body wall, which forms a waterway and a composite material forming at least a portion of the body wall. The monitor also includes an insert for forming a joint or a waterway component, which is mechanically coupled to the portion of body wall formed from the composite material.

In one aspect, the composite material comprises a polymer material, such as a reinforced polymer.

A suitable reinforced polymer includes a glass reinforced polymer matrix composite or the like.

In other aspects, the insert may comprise a bearing raceway for forming a swivel joint or a vein forming a veins waterway in the monitor, or a threaded coupler.

Accordingly, the present invention provides a monitor or other fire fighting device with a waterway that may be formed from a composite material while integrating molded or machined components, such as inserts, into the body that forms the monitor or device. These inserts may be formed from molded polymers or metal and, further, may provide reinforcement to the monitor or device. Consequently, the monitor or fire fighting device of the present invention has a reduced weight while still providing the capacity of prior metal-based monitors and, further, at a reduced cost of manufacturing.

Consequently, the method of the present invention may be used to produce non-metal monitor bodies and, further, for producing metal or non-metal monitor components that may be incorporated into the non-metal monitor body. As a result, the present invention reduces tooling and manufacturing costs for producing a monitor and its components.

In addition, internal veined geometry may be incorporated into the monitor body by use of inserts or cores that are formed with appropriate geometry. In addition, if inserts are used the inserts again may be used as load bearing members to add strength to the final part. As noted above, other members may also be included in the part design to add mechanical strength.

These and other objects, advantages, purposes, and features of the invention will become more apparent from the study of the following description taken in conjunction with the drawings.

### DESCRIPTION OF THE DRAWINGS

FIG. 1 is an exploded perspective view of a mold for forming a core that is used to form the body of a fire fighting device of the present invention;

FIG. 2 is a perspective view of a core formed from the molding apparatus of FIG. 1;

FIGS. 3A and 3B are perspective views of inserts that may be provided and located on the core and about which the material forming the body of the fire fighting device may be applied;

FIG. 4A is an exploded perspective view showing the mounting of the inserts onto the core;

FIG. 4B is a similar view to FIG. 4A illustrating the inserts mounted onto the core;

FIG. 5 is a perspective view of the core and inserts covered by a composite material to thereby form a fire fighting device body; and

FIG. 6 is a similar view of the fire fighting device body of FIG. 5 with the core removed leaving the body of the device integrated with the inserts.

### DETAILED DESCRIPTION OF THE PREFERRED EMBODIMENTS

Referring to FIG. 1, the numeral 10 generally designates a mold apparatus for forming a core 12 that is used to form a fire fighting device of the present invention. As will be more fully described below, the core may have incorporated thereon or therein one or more inserts that are separately formed, such as by molding, casting, or by other forming methods, which are then together with the core covered by a composite material, which then becomes integrated with the insert or inserts to form the body of the fire fighting device. In this manner, the fire fighting device of the present invention is formed from a composite material with one or more inserts that provide, for example, either a joint or a waterway component.

As best seen in FIG. 1, mold apparatus 10 includes two mold halves 14 and 16 each with a cavity 18 that is configured into the shape of one half of the waterway of the fire fighting device that is ultimately to be formed from core 12. In the illustrated embodiment, cavity 18 has a generally serpentine shape with semi-arcuate cross-section. When the two mold halves are joined or closed, the cavities, which extend or have a channel or port that extends to one side of the mold apparatus, is then filled through that channel or port with a material, such as a fluid material into the cavity. Suitable core materials may include a liquid wax, salt, rapid prototype powder, or sand. Alternately, a non-sacrificial core can be used if it is able to shrink so that parts with improper pull, such as a typical monitor body, may be removed after processing. For example, the core may be formed using an inflatable bladder.

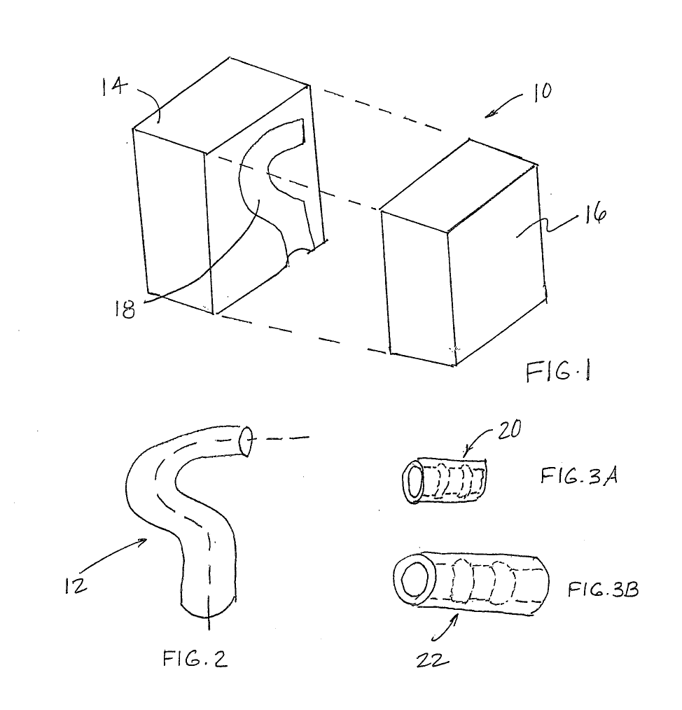

Once the core is allowed to solidify, for example, the mold is then opened and then removed from the cavity. As best seen in FIG. 2, once removed, core 12 will have the shape of the desired waterway. After the core is removed, the core may then be used to form the body of the monitor.

To form the monitor body, a polymer or composite material is applied to the core to produce the desired shape of the monitor body. For example, the polymer or composite material may be applied for example by a spray deposition process using spray guns. Alternately, the monitor body may be formed by wrapping core 12 with a composite fabric, which is imbedded with a composite material. In each case, when the material is at least partially cured, the core may then be removed.

Optionally, the material forming the monitor body may be compacted onto the core by hand, for example, with the use of rollers prior to curing. To cure the monitor body, the part may be left to cure for a preset minimum time or may be exposed to elevated temperatures, for example in an oven or auto clad, again for a preset time. As noted above, once cured or at least partially cured, the core may be removed from the monitor body. The core may be removed by heating or breaking, or deflating in the case of the core formed from the inflatable bladder.

When formed from fabric, the fabric may be applied on the core by hand by laying the composite fabric on the core. Another example includes filament winding or placing fiber or yarn with a polymer matrix on the core. For example, the filament winding or fiber may be wrapped or placed on the core. Again, the polymer matrix in the filament winding or fiber or yarn is then either allowed to cure or cured by exposure to elevated temperatures.

Alternately, the core may be made from a slightly rigid, but low friction material, such as TEFLON. In this application, the core may then further include a reinforcing layer, such as an outer layer, which provides structural integrity to the low friction material. For example, a suitable reinforcing or outer layer may include layer of glass filled nylon, an over molded layer formed from a polymer, or a layer or layers of fiberglass. In this application, the core may be left in place when forming the body of the monitor to become an integral part of the monitor body, with the low friction material provide an internal waterway with reduced friction.

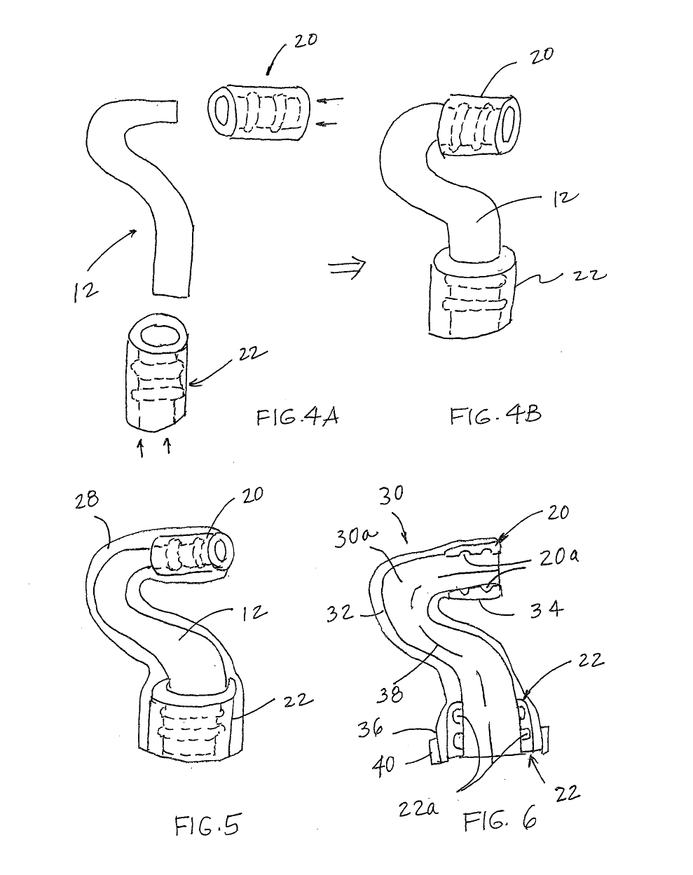

Referring to FIGS. 3A and 3B, one or more inserts 20 and 22 may be incorporated into the monitor body. For example, referring to FIGS. 4A, 4B, and 5, the inserts may be located on the core prior to the application of the polymer or composite material. For example, the core may be formed with locating structures, for example recesses or ribs in or on which the respective inserts may be mounted. Alternately or in addition, the inserts may be mounted using a friction or compression fit between the insert and the core. Once located about or in the core, the polymer or composite material is then applied over the core and over the insert(s). Optionally, the inserts may similarly be formed with structures that allow the polymer or composite material to extend or flow into the insert such that the polymer or composite material may form a mechanical interlock between the polymer or composite material forming the monitor body and the respective insert. After the polymer or composite material is applied over the insert or inserts and core, and the polymer or composite material is allowed to cure, the polymer or composite material and the inserts are integrated, such as illustrated in FIG. 6. Again, the core may be removed after the polymer or composite material is at least partially cured.

In the illustrated embodiment, inserts 20 and 22 comprise annular bodies or collars with each having formed therein one or more grooves, which may be used to form a raceway for a swivel joint or for receiving an O-ring seal. In this manner, the inserts may form a component of a joint for the monitor body.

Inserts 20, 22 may be formed from a metal material or may be molded from another or similar polymer or composite material. When formed from a non-metal material, the polymer or composite material forming the monitor body may ultimately fuse with the respective insert due to chemical reactions between the respective polymers in addition to or in lieu of any mechanical interlocking. In addition to providing components for one or more joints for the monitor, the inserts may be in the form of waterway components, such as a nozzle coupler or a vein or inlet or outlet bodies. For example, the metal or non-metal inserts may be formed by machining or by injection molding, as would be understood to those skilled in the art.

In addition, core 12 may be formed to provide accommodations for accepting rings, such as metal rings, which may be mounted about the core by simply slipping the metal ring over the core prior to the polymer composite deposition process. In addition to forming joints or waterway components, inserts therefore may be provided to provide reinforcement to the monitor body wall. For example, in addition to mounting the inserts on the core, inserts may be mounted to the monitor body wall after deposition but prior to curing such that the insert may be integrated into the body wall. For example, suitable inserts may include metal straps or plates or pins for example formed from higher strength material than the actual body wall or of similar strength to the monitor body wall but which have increased thickness to increase the cross-section at specific locations on the monitor body wall. For example, a suitable insert may include a metal or non-metal strap around the outer diameter of critical areas of the monitor body. The use of metal straps or non-metal straps around the outer diameter of the polymer composite material may be combined with a metal or non-metal insert provided on the interior diameter of the monitor body wall, which was previously applied to the core prior to the deposition process. Further, the outer insert may then be clamped about the inner insert, for example using bolts or threaded rods, provided in either the inner or outer insert. In this manner, ether separately or together, the strap or straps may provide reinforcement to critical areas of the monitor body. Further, the strap may be used to provide a stronger bond between the polymer or composite material and the insert that is located on the inner diameter of the monitor body wall. It should be understood that any of the other inserts contemplated herein could employ studs, clamps, or other fasteners to provide an optional clamping or fastening function about the monitor body and/or to another insert provided on the inside or outside of the monitor body.

In addition, pre-stressed inserts may be used. For example, when forming the core, an insert may be located in the cavity and when located in the cavity compressed and held in its compressed state by the material forming the core hardens. Once the polymer or composite material is then applied to the core and the core removed, the polymer or composite material forming the monitor body wall will retain the insert in its compressed state or pre-stressed state.

Consequently, the method of the present invention may be used to form a monitor body 30 in which at least a portion of the monitor body wall is formed from a polymer or composite material. In addition, one or more inserts may be integrated with the portion of the body wall that is formed from the polymer or composite material. In the illustrated embodiment, the entire body wall 32 is formed from a polymer or composite material and, further, includes at least two inserts with one insert being provided, for example at the outlet end 34 and a second insert provided at the inlet end 36 of monitor body 30. Further, as previously described, inserts 20 and 22 may be configured to provide a component of a swivel joint for monitor body 30 and to that end may include one or more grooved recesses or slots 20a, 20b 22a, 22b, respectively for receiving ball bearings and/or a O-ring seal, respectively. Further, as previously described, monitor body 30 may incorporate additional inserts, such as an insert 38 which forms a vein in the waterway 30a of monitor body 30. Optionally, as described in reference to the method for forming the monitor body, monitor body 30 may incorporate inserts, such as inserts 40 in the form of plates or annular rings, which may be provided at high stress locations of the monitor body and, further, may be provided for example at the outer diameter that corresponds to the inner diameter where the insert forming the swivel joint component are located to reinforce the monitor body at the swivel joint.

Accordingly, the present invention provides a fire fighting monitor and a method for making a fire fighting monitor that may significantly reduce the cost and weight of the monitor while still providing the same or similar capacity to a corresponding metal monitor. As described above, the present invention provides for non-metal part geometry suitable for monitor components, including monitor waterway components.

While several forms of the invention have been shown and/or described, other changes and modifications will be appreciated by those skilled in the relevant art. Therefore, it will be understood that the embodiment shown in the drawings and described above is merely for illustrative purposes, and is not intended to limit the scope of the invention which is defined by the claims which follow as interpreted under the principles of patent law including the doctrine of equivalents.

The embodiments of the invention in which an exclusive property right or privilege is claimed are defined as follows:

1. A method of forming a fire fighting monitor, the monitor having a monitor body with a non-linear waterway, said method comprising:
forming a core in the shape of the non-linear waterway;
applying a composite material over the core; and
curing the composite material to thereby form the fire fighting monitor body.

2. The method according to claim 1, wherein said forming comprises forming a core from wax, salt, rapid prototype powder, sand, an inflatable bladder, or a slightly rigid low friction material reinforced by a more rigid outer layer.

3. The method according to claim 2, wherein said forming comprises forming a core from an inflatable bladder.

4. The method according to claim 3, wherein said removing includes deflating the inflatable bladder.

5. The method according to claim 1, wherein said curing includes exposing the core to an elevated temperature.

6. The method according to claim 5, wherein said exposing the core to an elevated temperature includes heating the core in an oven.

7. The method according to claim 1, wherein said applying a composite material over the core includes applying a fabric.

8. The method according to claim 7, wherein said applying a fabric includes wrapping the core in fabric.

9. The method according to claim 1, further comprising forming an insert, and locating the insert on or in the core.

10. The method according to claim 9, wherein said forming an insert includes a forming an insert with at least one recess, and said applying the composite material includes extending the composite material into the recess to thereby mechanically couple the composite material to the insert.

11. The method according to claim 10, wherein said applying the composite material includes applying the composite material over the insert.

12. The method according to claim 9, wherein said forming an insert includes molding the insert, such as by injection molding.

13. The method according to claim 9, further comprising coupling the insert to the core.

14. The method according to claim 13, wherein said coupling includes forming a friction fit or a compression fit between the insert and the core.

15. The method according to claim 9, wherein said locating includes forming a recess in said core and positioning the insert in the recess to thereby locate the insert on or in the core.

16. The method according to claim 1, wherein said applying a composite material includes spraying the composite material over the core.

17. The method according to claim 1, further comprising providing a reinforcing member in or about at least a portion of said composite material.

18. The method according to claim 1, further comprising applying pressure on the composite material onto the core.

19. The method according to claim 1, further comprising removing the core after the fire fighting monitor body is at least partially cured.

20. A fire fighting monitor comprising:
a monitor body, said monitor body having a body wall and a composite material forming at least a portion of said body wall, said body wall forming a waterway; and
an insert forming a joint or a waterway component, and said insert mechanically coupled to said portion of said body wall formed from said composite material.

21. The monitor according to claim 20, wherein said composite material comprises a polymer material.

22. The monitor according to claim 21, wherein said composite material comprises a reinforced polymer.

23. The monitor according to claim 21, wherein said reinforced polymer comprises a glass reinforced polymer matrix composite.

24. The monitor according to claim 20, wherein said insert comprises a bearing raceway for forming a swivel joint.

25. The monitor according to claim 20, wherein said insert comprises a vein, said vein forming a veined waterway in said monitor.

26. The monitor according to claim 20, wherein said insert comprises a threaded coupler.
